(19) United States
(12) Patent Application Publication
(10) Pub. No.: US 2008/0209271 A1
(43) Pub. Date: Aug. 28, 2008

(54) DEVICE AND METHOD FOR TEST COMPUTER

(75) Inventors: YU-LIN LIU, Shenzhen (CN); LI-PING FAN, Shenzhen (CN); RUN-DONG ZENG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu--Cheng (TW)

(21) Appl. No.: 11/831,970

(22) Filed: Aug. 1, 2007

(30) Foreign Application Priority Data
Feb. 27, 2007 (CN) 200720200104.2

(51) Int. Cl. G06F 11/00

(52) U.S. Cl. 714/36; 714/E11.001

(57) ABSTRACT

A test device for testing startup performance of a computer comprises a setting circuit for recording triggering times for triggering startup of the computer and a time interval between two successive startups of the computer, a monolithic chip (10) comprising an input pin connected to the setting circuit, and an output pin for connection to the computer, the input pin being configured for receiving signals containing therein from the setting circuit, the output pin being configured for sending a computer startup signal, at the time interval, to the computer in response to the received signals; and a display device (20) electronically connected with the monolithic chip, the display device being configured for displaying at least one of the triggering times and the time interval.

### BACKGROUND

1. Field of the Invention

The present invention relates to test devices and methods, and more particularly to a test device and method for testing startup performance of a computer.

2. Description of Related Art

After a computer is produced, quality tests are required. One of the tests is for testing startup performance of the computer. In testing, the computer is powered on and off repeatedly.

A conventional test involves connecting the computer to an AC power supply, and then powering it on and off by controlling the AC power supply. However, the AC power supply has a complicated configuration and is expensive. When many computers need testing, many AC power supplies are required.

What is needed, therefore, is a test device with simple structure and method that automatically controls the computers to be powered on and off repeatedly.

### SUMMARY

A test device for testing startup performance of a computer comprises a setting circuit for recording triggering times for triggering startup of the computer and a time interval between two successive startups of the computer, a monolithic chip comprising an input pin connected to the setting circuit, and an output pin for connection to the computer, the input pin being configured for receiving signals containing therein from the setting circuit, the output pin being configured for sending a computer startup signal, at the time interval, to the computer in response to the received signals; and a display device electronically connected with the monolithic chip, the display device being configured for displaying at least one of the triggering times and the time interval. A method for testing startup performance of a computer, comprising the steps of: providing a test device, determining triggering times for triggering startup of the computer and a time interval between two successive startups of the computer, inputting the triggering times and the time interval into the setting circuit, causing the monolithic chip to run in a sleeping state if the triggering times is equal to zero, sending a startup triggering signal from the monolithic chip to the computer, if the triggering times is greater than zero and the time interval is elapsed, and then reducing the triggering times by one.

Other advantages and novel features will be drawn from the following detailed description of preferred embodiments with attached drawings, in which:

### BRIEF DESCRIPTION OF THE DRAWINGS

FIG. 1 is a circuit diagram of a testing device in accordance with a preferred embodiment of the present invention; and

FIG. 2 is a flow chart of a working process of a system using a monolithic chip in accordance with a preferred embodiment of the present invention.

### DETAILED DESCRIPTION OF THE EMBODIMENT

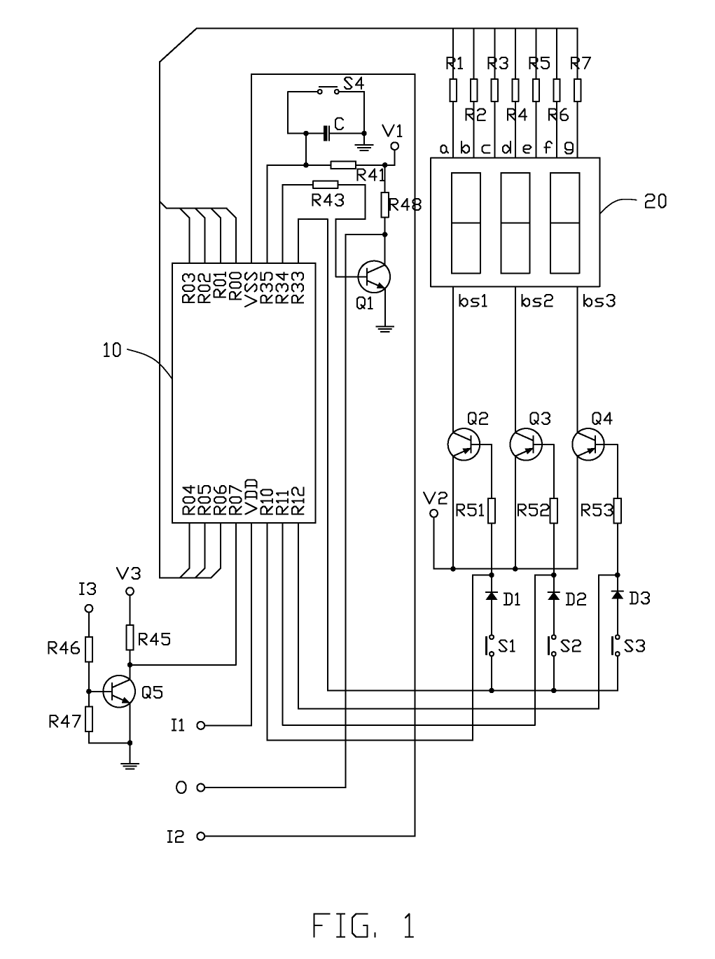

Referring to FIG. 1, a testing device in accordance with a preferred embodiment of the present invention includes a monolithic chip 10, a seven-segment LED display 20, and a setting circuit.

The seven-segment LED display 20 includes three seven-segment light emitting diodes (LEDs). The seven-segment LED display 20 has three individual digits. The seven-segment LED display 20 includes seven cathodes a-g and three common anodes bs1-bs3. The three common anodes bs1-bs3 of the seven-segment LED display 20 are connected respectively to three collectors of three PNP transistors Q2, Q3, Q4. Three emitters of the PNP transistors Q2, Q3, Q4 are commonly connected to a voltage source V2.

The setting circuit includes three button switches S1, S2, S3 and three diodes D1, D2, D3. Each button switch includes a first terminal and a second terminal. The first terminals of the button switches S1, S2, S3 are connected respectively to positive terminals of the diodes D1, D2, D3. The negative terminals of the diodes D1, D2, D3 are connected respectively to three bases of the PNP transistors Q2, Q3, Q4 via three resistors R51-R53.

A detailed description of a relationship between the chip 10 and other circuits follows:

The monolithic chip 10 is an MCF0504 microcontroller, which includes seven output pins R00-R06, three pins R10-R12, a pin R33, a pin R34, a pair of pins VDD, VSS, and a pin R35.

The seven output pins R00-R06 are connected respectively to the seven cathodes a-g of the seven-segment LED display 20.

The three pins R10-R12 are connected respectively to the negative terminals of the diodes D1, D2, D3 for sending out a low level signal about 2 milliseconds in turn repeatedly to enable the seven segment LEDs to work in turn, in viewing the LEDs it will seem they are always on because of the rapidity of the flashing of the LEDs. For example, when the pin RIO sends out a low level signal, the base of the PNP transistor Q2 is at low level, thereby turning on the PNP transistor Q2. Thus, the anode bs1 of the corresponding seven-segment LED is at high level to enable the corresponding seven-segment LED to work.

The pin 33 is connected to the second terminals of the button switches S1, S2, S3. Normally, the pin R33 is at a high level. When one button switch is pressed, the pin R33 will receive a signal from the one button switch, and the monolithic chip 10 will identify which button switch is pressed. For example, a momentary press of the button switch S1 will enable the pin R33 at low level due to the low voltage level between two terminals of the diode D1.

The pin R34 is connected to a base of an NPN transistor Q1. An emitter of the NPN transistor Q1 is connected to ground. A collector of the NPN transistor Q1 is connected to a voltage source V1 via a resistor R48 and to an output terminal O. The output terminal O is connected to the computer to send a signal to the computer for controlling the computer to startup/shut down. The pin R34 alternately sends out a high level signal and a low level signal. When the pin R34 sends out a high level signal, the NPN transistor Q1 is turned on. Thus, the output terminal O sends out a low level signal to trigger the computer to startup/shut down.

The pins VDD, VSS are connected respectively to input terminals I1, I2. The input terminals I1, I2 are connected respectively to a positive terminal and a negative terminal of a power supply.

The pin R35 is connected to a reset circuit. The reset circuit includes a button switch S4 and a capacitor C. The pin R35 is connected to one terminal of the button switch S4 and one terminal of the capacitor C. The other terminal of the button switch S4 and the other terminal of the capacitor C are connected to ground. The pin R35 is also connected to the voltage source V1 via a resistor R41. The monolithic chip 10 is reset when the button switch S4 is triggered.

Before test, the number of times and the time intervals need to be set by pressing the button switches S1, S2, S3.

The button switch S1 is used for selecting test parameters by triggering the button switch S1. The button switch S2 is used for setting the value of selected test parameter. The button switch S3 is used for entering the setting value to be saved in the monolithic chip 10. The test parameters include a number of times (between 0 and 600) and time intervals (between 0 and 60 minutes). The time intervals are set in minutes. A momentary press of the button switch S1 will switch the current display to a number of times setting mode. After the number of times has been set, a momentary press of the button switch S1 will switch the display into the time intervals setting mode. When the number of times mode is selected, each momentary press of the button switch S2 will increment the displayed number by one. After the value of ones has been set, a momentary press of the button switch S3 enters the setting value to be saved in the monolithic chip 10. After that, each momentary press of the button switch S2 will increment the displayed number by 10. After the value of tens has been set, a momentary press of the button switch S3 enters the setting value to be saved in the monolithic chip 10. Lastly, each momentary press of the button switch S2 will increment the displayed number by 100. After the value of tens has been set, a momentary press of the button switch S3 enters the setting value to be saved in the monolithic chip 10. Then pressing S1 again will switch the display to time interval mode and the process as above is followed to set the time interval.

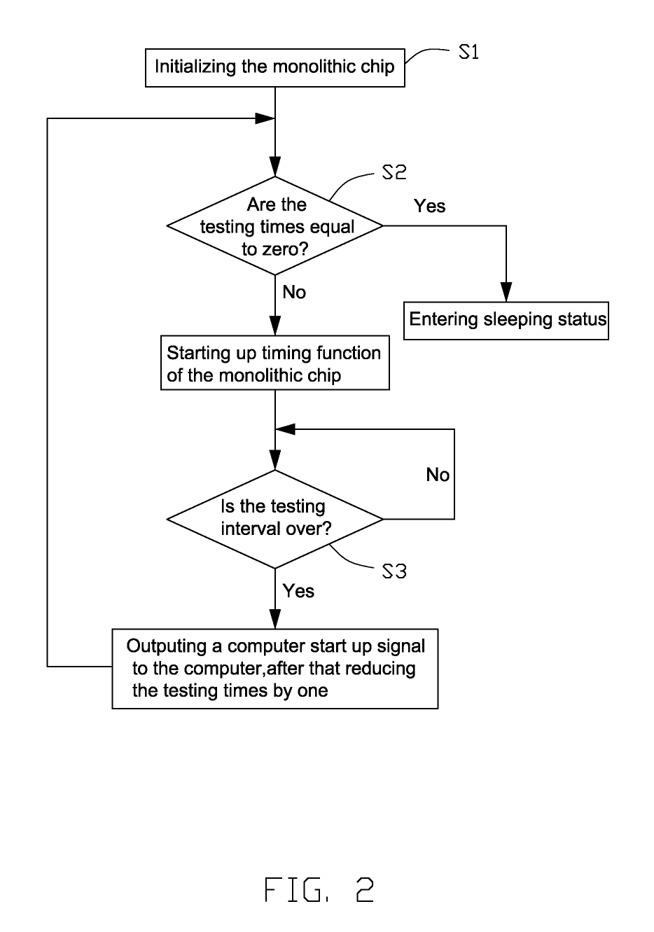

Referring also to FIG. 2, the working process of a system using the monolithic chip 10 includes a plurality of steps as follows:

Step 1: initializing the monolithic chip 10;

Step 2: the system checking if the number of times is equal to zero. If the number of times is equal to zero, the system enters a sleeping state; if the number of times is not equal to zero, the system starts up a timing function therein;

Step 3: the system checking if a predetermined test interval has elapsed if the number of test times is not equal to zero. If the predetermined test interval is over, the monolithic chip outputs a high level signal to turn on the NPN transistor Q1 and the output terminal O outputs a low level signal to the computer to power on/off the computer. After that, the system reduces the testing times by one and the system returns to the step 2; if the predetermined test interval is not over, the system returns to the step 3.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A test device for testing startup performance of a computer, comprising:
a setting circuit for recording triggering times for triggering startup of the computer and a time interval between two successive startups of the computer;
a monolithic chip comprising an input pin connected to the setting circuit, and an output pin for connection to the computer, the input pin being configured for receiving signals containing therein from the setting circuit, the output pin being configured for sending a computer startup signal, at the time interval, to the computer in response to the received signals; and
a display device electronically connected with the monolithic chip, the display device being configured for displaying at least one of the triggering times and the time interval.

2. The test device as described in claim 1, wherein the display device comprises a plurality of seven-segment LEDs, the plurality of seven-segment LEDs comprising seven first terminals, the monolithic chip comprising seven pins connected to the seven input terminals of the display device configured for controlling the display device, each of the seven-segment LEDs having a second common terminal connected to a corresponding pin of the monolithic chip.

3. The test device as described in claim 2, further comprising a switch device, wherein each of the second common terminals of the seven-segment LED is connected to the corresponding pin of the monolithic chip via the switch device.

4. The test device as described in claim 3, wherein the switch device is a PNP transistor, a collector of the PNP transistor is connected to the corresponding second common terminal, an emitter of the PNP transistor is connected to a voltage source, and a base of the PNP transistor is connected to the corresponding pin of the monolithic chip.

5. The test device as described in claim 4, wherein the setting circuit comprises a plurality of button switches for manually inputting the triggering times and the time interval, and each button switch has a first terminal connected to a pin of the monolithic chip for receiving signals from the setting circuit.

6. The test device as described in claim 5, wherein each button switch has a second terminal connected to the selecting pin of the monolithic chip.

7. The test device as described in claim 6, wherein a positive terminal of a diode is connected to the second terminal of each button switch and a negative terminal of the diode is connected to the selecting pin of the monolithic chip.

8. The test device as described in claim 1, further comprising a switch device, wherein the output pin of the monolithic chip is connected to a control terminal of the switch device, the switch device having a first terminal connected to a voltage source via a resistor and to an output terminal connected to the computer, the switch device having a second terminal connected to ground, the monolithic chip being configured for sends a computer startup signal to the computer via the switch device.

9. The test device as described in claim 8, wherein the switch device is an NPN transistor, the first terminal of the switch device is a collector of the NPN transistor, the second terminal of the switch device is an emitter of the NPN transistor, and the control terminal of the switch device is a base of the NPN transistor.

10. The test device as described in claim 1, further comprising a reset circuit with the monolithic chip connected thereto, wherein the reset circuit comprises a switch device and a capacitor, and a first terminal of the switch device and a first terminal of the capacitor are connected to the monolithic chip and a second terminal of the switch device and a second terminal of the capacitor are connected to ground, the first terminals of the switch device and the capacitor are connected to a voltage source via a resistor.

11. The test device as described in claim 1, wherein the monolithic chip is an MCF0504 chip.

12. A method for testing startup performance of a computer, comprising the steps of:
providing a test device as described in claim 1;
determining triggering times for triggering startup of the computer and a time interval between two successive startups of the computer;
inputting the triggering times and the time interval into the setting circuit;
causing the monolithic chip to run in a sleeping state if the triggering times is equal to zero;
sending a startup triggering signal from the monolithic chip to the computer, if the triggering times is greater than zero and the time interval is elapsed, and then reducing the triggering times by one.
